(19) United States
(12) Patent Application Publication
(10) Pub. No.: US 2010/0305774 A1
(43) Pub. Date: Dec. 2, 2010

(54) System for Generating Cost-Efficient Low Emission Energy

(76) Inventor: Steven F. Miller, Wyndmoor, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/533,728

(22) Filed: Jul. 31, 2009

Related U.S. Application Data
(60) Provisional application No. 61/182,903, filed on Jun. 1, 2009.

(51) Int. Cl. G06F 1/26; G06Q 40/00; G06Q 50/00

(52) U.S. Cl. 700/297; 705/37

(57) ABSTRACT

A method of economically substituting higher-priced clean energy sources for lower-price energy sources with negative environmental attributes by using a portion of the return on investment in a portfolio of residential, commercial, institutional or industrial energy efficiency measures to offset the cost of higher-priced, clean energy. Proceeds from investments and the monetization of the environmental benefits of the invention would are used to subsidize the cost of natural gas-fired plants so that they can economically displace coal-fired plants or other types of plants with similar negative environmental attributes as a source for base load power generation.

### PRIORITY CLAIM

This application claims priority to U.S. Provisional Patent Application No. 61/182,903, filed Jun. 1, 2009, the entire disclosure of which is hereby incorporated by reference.

### FIELD OF THE INVENTION

The invention generally relates to the fields of energy generation, investing, and environmental regulation, and in particular to the method of using gains from an investment in energy-efficiency measures to offset the cost of power generation through natural gas combustion.

### BACKGROUND

The electric utility industry faces a number of fundamental issues, some of which are described below. First and foremost, utilities must meet the demand for new generating capacity in the face of substantial permitting and financing challenges. Second, utilities must comply with new environmental regulations by 2015 to reduce harmful air emissions, principally from coal-fired plants. Compliance with these known regulations and pending CO2 regulations which in large measure are directed at these polluting plants have a number of implications for utilities, including the following: (i) compliance will require significant capital, (ii) utilities are facing and will expect to face substantial permitting and regulator challenges in seeking approval for expenditures on these plants, (iii) and it may be preferable or required to close inefficient or polluting plants before the end of their life cycles, exacerbating the need for new capacity. Third, both existing and upcoming state and federal regulations are forcing utilities to develop or contract for significant new clean energy generating capacity; additionally, such capacity in many cases cannot replace generating capacity from base load coal-fired plants. Against this backdrop are (i) pending federal CO2 emissions regulations, which if enacted would the increase the costs of building and operating coal-fired generating plants and (ii) new requirements for utilities to invest in energy efficiency assets. Fourth, environmental groups and the general public, out of concerns for the environment, are increasingly resistant to utilities' requests to expend capital relative to coal-fired generating assets.

Historically, coal-fired plants have been the preferred type of generating capacity, particularly for base load power plants. In 2008, coal-fired plants provided approximately 30% of the installed generating capacity and approximately 50% of the power produced in the US. Coal-fired power plants have the advantage of low and stable fuel costs. The future for coal-fired plants, however, is uncertain as they emit large quantities of pollutants (including CO2) into the air. Most new coal plants that have been proposed for construction in the US since 2007 have been cancelled or put on hold and many of the utilities' requests to upgrade existing coal plants have been stalled due to concerns expressed by the general public and the financial community related to CO2 emissions and compliance costs.

Recently, utilities have been contracting for increasing amounts of clean energy generating capacity, predominantly from wind and solar facilities to meet state renewable energy requirements. While these plants fill a need for the utilities, they cannot be used for base load power, which is supplied by plants that operate continuously at maximum output. Base load plants, which typically produce electricity at the lowest cost of any type of power plant, are predominantly coal, nuclear and hydroelectric plants.

Natural gas-fired combined cycle gas turbine (CCGT) generating plants are far easier to permit and build than either coal or nuclear plants, are less costly to construct and emit significantly lower emissions than coal plants (including approximately 50% less CO2). CCGT plants do not produce SO2 or mercury emissions (meaning they have zero SO2 and mercury compliance costs) and NOx control for CCGT plants is less than 20% of the cost of NOx control for comparable coal plants. A negative aspect of CCGT economics that has prevented utilities from using CCGT technology for base load capacity has been high and volatile natural gas prices (and, in certain geographic locations, lack of availability of natural gas). Absent natural gas price and supply issues, CCGT would be the preferred option for base load (and intermediate load) generating capacity versus either nuclear or coal-fired power plants.

### SUMMARY OF THE INVENTION

A method known as Direct Coal Displacement (or DCD) is described herein to economically substitute higher-priced clean energy sources for lower-price energy sources with negative environmental attributes. This method uses a portion of the return on investment in a portfolio of residential, commercial, institutional or industrial energy efficiency measures (EEMs) to offset the cost of higher-priced, clean energy, thereby allowing realization of environmental benefits at reduced costs to energy consumers and utilities. This method can most significantly be employed in the electric power generation sector to reduce reliance on coal-fired and to a lesser extent oil-fired electric generating plants. Coal plants are a preferred power source due to low and non-volatile fuel costs; however, concerns with the emission of significant air pollutants are making coal-fired plants increasingly difficult to permit and the requirement to fund emissions compliance measures are making coal-fired plants increasingly expensive to operate. Natural gas-fired generating plants are easier to permit, emit significasntly less pollutants and are less costly to build than coal-fired generating plants; however, because prices for natural gas can be significantly higher and more volatile than those for coal, gas-fired generating plants are not a preferred source for base load power, despite the comparative environmental benefits. Using this method, proceeds from investments in energy efficiency measures and the monetization of the environmental benefits would be used to subsidize the cost of natural gas-fired plants so that they could economically displace coal-fired plants as a source for base load power generation.

The present system (DCD) provides a method to offset the cost of base load power generation by using natural gas-fired combined cycle gas turbine plants. By so doing, utilities may be able to increase capacity and comply with government emissions regulations without a significant increase in cost to the company or the consumer. In addition, unused carbon allowances could be sold, further increasing revenue for the benefit of the utilities and/or their rate payers.

The present system also provides a method for affecting or controlling the dispatch order of a series of electrical generation facilities. Specifically, by linking a stream of revenue with the operation of a particular facility, a low emission fuel facility that would otherwise be operated as an intermediate or peaking load facility is used to provide base load or intermediate load capacity. By doing so, the low emission fuel facility displaces the base load or intermediate load capacity of a facility that creates greater emissions than the low emission fuel facility.

Additionally, the present system provides a method for controlling or influencing the capital decisions on whether to build or upgrade a facility to create more capacity or to reduce emissions. By using a DCD arrangement, the excess capacity of under-utilized low emission fuel facilities can be used to offset the capacity of a facility that creates greater emissions than the low emission fuel facility. By using the underutilized capacity in an economical manner, the utility may be able to replace the capacity of a coal or oil burning facility without building new capacity.

Additionally, the present system provides a method which can lead to the increased implementation of EEMs. The present system provides a method for providing capital that can be used to invest in EEMs. The present system can reduce the net cost of the EEMs and eliminate the capital cost barrier that residential, commercial, institutional or industrial energy users (Hosts) may face which impede the implementation of EEMs.

The present system can work in conjunction with utility-sector programs, which encompass all programs paid through utility consumer rates or other charges on utility bills and includes programs administered by utilities as well as programs where utilities collect the revenue for other parties. DCD can compliment utility-sector programs through joint marketing with utilities for the purpose of increasing the number of EEM's installed or supplementing the financial incentives available under such programs.

### DESCRIPTION OF THE DRAWINGS

The foregoing summary and the following detailed description of the preferred embodiments of the present invention will be best understood when read in conjunction with the appended drawings, in which:

FIG. 1 is a flowchart illustrating the relational structure in a method of offsetting the costs associated with natural gas power plants through energy efficiency measures investment.

FIG. 2 is a flowchart illustrating the financial interactions among the entities illustrated in FIG. 1.

FIG. 3 is an alternative flowchart illustrating the structure of the system in FIGS. 1-2.

FIG. 4 is a flowchart illustrating an alternative relation structure in a method of offsetting the costs associated with natural gas power plants through energy efficiency measures investment.

FIG. 5 is a flowchart illustrating the financial interactions among the entities illustrated in FIG. 4.

### DETAILED DESCRIPTION OF THE INVENTION

Referring now to the drawings in general, a Direct Coal Displacement (DCD) system for generating cost-effective low emission electricity will be described. The system is directed to creating and operating reduced emission electricity generation facilities in a manner that is cost effective at current electric generation costs. The system further provides for increased implementation and use of energy efficiency measures (EEMs) by energy consumers. The net result is a reduction in the emissions created during electricity generation, and a reduction in the amount of energy consumed by Hosts. Both of these results can be accomplished at a lower cost to either the electricity generating entity or the energy customers than is otherwise achievable under presently-available methods.

The present system leverages several competing factors that generally impede the adoption of EEMs and the creation of electrical generation facilities that utilize fuels that produce lower levels of undesirable emissions. Specifically, although EEMs may create a net savings in the long term, the cost of adopting EEMs typically requires increased up front capital expenditures. These and other factors impede the adoption of the EEMs. In contrast, some electrical generation facilities that use fuels that create fewer undesirable emissions may cost less to build, however, the ongoing costs of operating such facilities may be higher than an electrical generation facility that uses fuels that generate higher levels of undesirable emissions. These increased operating costs frequently impede energy generating companies from building such facilities and utilities from contracting for lower emission power.

The present system links the reduced cost of building the lower emission electrical generation facilities with the long term reduced energy cost resulting from use of the EEMs. Specifically, the decreased capital requirements of building a lower emission electrical generation facility can be used to offset some or all of the capital requirements of the EEMs. At the same time, the ongoing cost savings of the EEMs can be utilized to offset the ongoing increased cost of the lower emission electricity generation facility. The present system can be utilized to facilitate the creation of any of a number of power generation facilities with reduced emissions. In particular, the system can be used to promote the creation of power generation facilities that use fuels that generally create lower levels of undesirable emissions, such as carbon dioxide, sulfur dioxide, nitrogen oxides, and mercury. In the following discussion, a power generation facility using a fuel that generally creates lower levels of undesirable emissions is referred to as a low emission fuel facility or LEF power plant. A facility that uses fuels that generally create higher levels of undesirable emissions is referred to as a base load power plant in the following discussion. Examples of base load and LEF power plants are coal-fired power plants and natural gas-fired power plants respectively. A natural gas-fired plant is an example of a low emission fuel power plant, whereas a coal-fired plant is an example of a base load power plant.

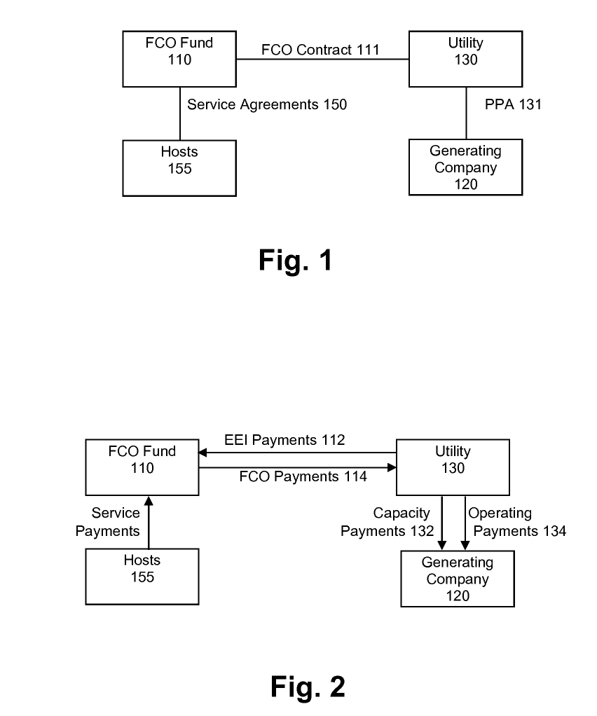

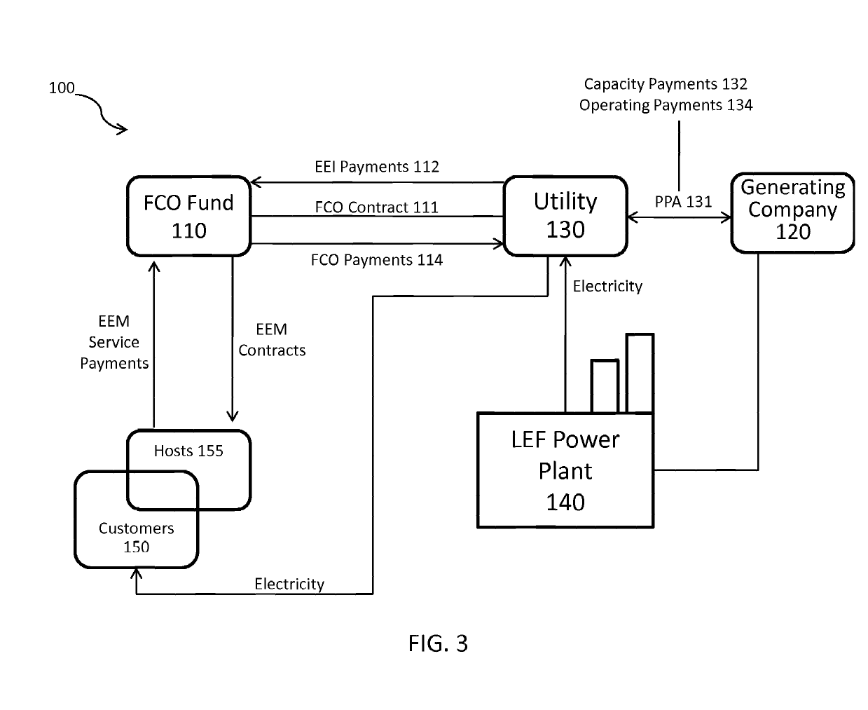

Referring now to FIGS. 1-3, one embodiment of the system is illustrated. A generating company 120 enters into an agreement such as a power purchase agreement (PPA 131) with a utility 130 under which the generating company agrees to provide the utility company with an amount of electricity from its LEF power plant 140 that the utility provides to electrical consumers. The PPA may provide for a guaranteed power capacity that the generating company 120 will provide for the utility 130. The PPA will also likely include a price per megawatt actually provided to the utility. In return, the utility 130 agrees to make payments, such as capacity payments 132 based on the guaranteed capacity to be provided under the PPA, and operating payments 134 based the electricity provided to the utility.

Typically, the capacity payments 132 and operating payments 134 are based upon the type of electricity generating plant being constructed. For instance, if the plant being constructed is an LEF power plant, the capacity payments would be CP1 and the operating payments would be OP1. Similarly, if the plant being constructed is a base load power plant, such as coal-fired plant, the capacity payments would be CP2 and the operating payments would be OP2. In such a scenario, CP2>CP1 and OP2<OP1.

In the present instance, the facility is an LEF power plant 140 and the capacity payments are based on an LEF power plant. The cost of constructing the LEF power plant 140 is less than the cost of constructing a base load facility. The cost of operating the LEF power plant 140 is more than the cost of operating a base load facility.

The FCO Fund 110 enters into an agreement, referred to herein as an FCO Contract (FCO), with a utility 130 under which the utility makes Electrical Efficiency Investment (EEI) Payments 112 to the FCO Fund 110 and the FCO Fund 110 makes FCO Payments 114 to the utility 130.

The EEI Payments 112 and the FCO Payments 114 are based upon a fuel and construction cost differential between a base load power plant and the LEF Plant. Accordingly, the utility company agrees to make to the FCO Fund 110 EEI Payments 112 in the amount of CP2 less CP1 and the FCO Fund 120 agrees to make FCO Payments 114 to the utility 130 in the amount of OP2 less OP1.

The FCO Fund 110 enters into Service Agreements with Hosts 155 to increase the implementation of EEMs designed to reduce the Hosts' energy usage. Frequently, Hosts are hesitant to adopt EEMs because of increased up front capital requirements. The FCO Fund 110 provides capital to fund the purchase and/or implementation of EEMs. The Hosts 155 need not be consumers of the electricity that is produced by the LEF Power Plant 140. In fact, the Hosts need not be consumers of the electricity provided by the utility. The Hosts may be in a geographically remote location from the area served by the utility 130. As such, a Host 155 may be a subset of the energy consumer population served by the utility, or the Host may be separate from the consumer population served by the utility. (Hosts may also use energy from sources other than electricity, such as natural gas, heating oil, etc.)

A Host 155 may be any residential, commercial, institutional or industrial energy consumer. The FCO Fund 110 enters into a Service Agreement with a Host 155 to provide resources for implementing EEMs. The resources may include aspects of the EEMs, or the resources may be the capital necessary for obtaining, installing, maintaining and/or operating an EEM. In response, the Host 155 agrees to provide Service Payments to the FCO Fund 110 for a period of time, which could but would not have to be based on the actual or anticipated savings from the EEMs. For instance, a Host may expect to recognize a savings per year due to implementation of EEMs. Based on this expectation, the Host 155 will provide a stream of Service Payments (SP) to the FCO Fund 110. The amount of the Service Payments may be proportional to the expected savings or may be a percentage of the expected savings or may be a given amount independent of energy savings. Alternatively, the Service Payments may be based on the actual savings rather than the expected savings from the EEMs. In such a scenario, the amount of the Service Payments may be proportional to the actual savings and/or may be a percentage of the actual savings. Alternatively, the Service Payments may be a fixed amount or a variable amount independent of a savings amount.

The utility would contract with the generating company under which it would make payments to the generating company in return for the generating company agreeing to provide power (under its agreement with the utility) at a reduced cost to reflect the payments to offset the gas costs made to the utility, or the utility may assign its rights to the payments under the FOC Contract 111 to the generating company in return for the generating company agreeing to provide power at a reduced cost reflecting these payments or through a variety of other means.

The FCO Fund 110 utilizes the EEI Payments from the FCO Contract 111 to implement a plurality of EEM investments as described above pursuant to a plurality of agreements with Hosts 155. The Hosts 155 provide a stream of Service Payments to the FCO Fund 110 as described above. The FCO Fund 110 uses the stream of Service Payments to fund FCO Payments 114 to the utility. The utility then uses the FCO payments to offset the fuel costs of the LEF power plant 140 under the PPA. Alternatively, the FCO payments may be made to the supplier of the fuel for the LEF power plant, the owner of the LEF power plant, a guarantor or another party related to the transaction involving the FCO Fund 110.

As can be seen from the foregoing, the coordination between the utility 130, the generating company 120, the FCO Fund 110 and the Hosts 155 creates a scenario in which power plants using low emission fuel can be constructed (and/or operated) without significantly increasing the cost to the utility or to the consumers. Further still, in light of various regulations and government programs, both the FCO Fund 110 and the generating company 120 may recognize additional benefits (such as from the reduced pollution of the LEF Generating Plant compared to the base load plant) that would help to further reduce the effective overall ongoing cost of power from the LEF power plant.

For instance, the system as described above leads to at least two results that are beneficial from an environmental standpoint. First, by encouraging the implementation of EEMs, the FCO Fund activities result in Hosts' reduced energy consumption relative to what the consumption would be in the absence of the EEMs. Another aspect that can reduce the ongoing cost of generating electricity is carbon offsets. Carbon offsets can be created when a reduction in CO2 emissions occurs. The carbon offsets result from CO2 emissions reduction required to maintain compliance with environmental regulations or pursuant to agreements to voluntarily reduce CO2 emissions. These offsets can be sold to other companies looking to decrease their impact on the environment or become compliant with federal or state regulation, providing another source of revenue to the utility or the FCO Fund 110.

The carbon offsets result from the operation of a low emission fuel power plant, which will create lower amounts of carbon emissions relative to a base load power plant. By demonstrating that the substitution of low emission fuel (such as natural gas) for coal as fuel for base load power generation would not have occurred without FCO payments, then the resultant reduction of emissions would result in the creation of carbon offsets. Carbon offsets can be sold to companies that desire (or are required) to reduce their carbon footprint.

In order to ensure entitlement to potentially available carbon offsets, the FCO Fund and the generating plant, and/or the utility link the operation of the LEF power plant with the reduced operation of a base load facility. Specifically, the operation of the LEF power plant and a base load plant, such as a coal-fired plant, are collectively recognized as an FCO Pair. All emissions that are avoided because of the operation of the LEF power plant rather than the base load power plant create carbon credits. Therefore, the generating company 120 agrees to schedule the LEF power plant as a base load resource rather than the base load plant. In other words, during periods of peak usage, generally, all of the power generating facilities will be operating at a high percentage of capacity to create electricity to meet the peak demand. When demand is lower during off-peak hours, some of the generation capacity is not required. Typically, when demand falls, the output of an LEF power plant is reduced before the output of the base load power plant since the base load power plant typically has lower fuel costs. However, in the present system, the generating company (or the utility) agrees to use the LEF power plant for base load power generation, such that during periods of reduced demand, the output of the base load plant of the FCO pair is reduced before the output of the LEF power plant is reduced. By doing so, the LEF power plant maximizes the carbon credits to be recognized due to the displacement of carbon emissions that would have been created if the base load facility of the FCO Pair had been operated rather than the LEF power plant of the FCO Pair.

In this embodiment, the FCO Fund would be responsible for planning, implementing, and monitoring EEM investments; ensuring that FCO payments result in verifiable displacement of coal with natural gas; and obtaining approval from a carbon exchange for certification of the carbon offsets and manage the sale of such offsets into the voluntary and/or compliance markets.

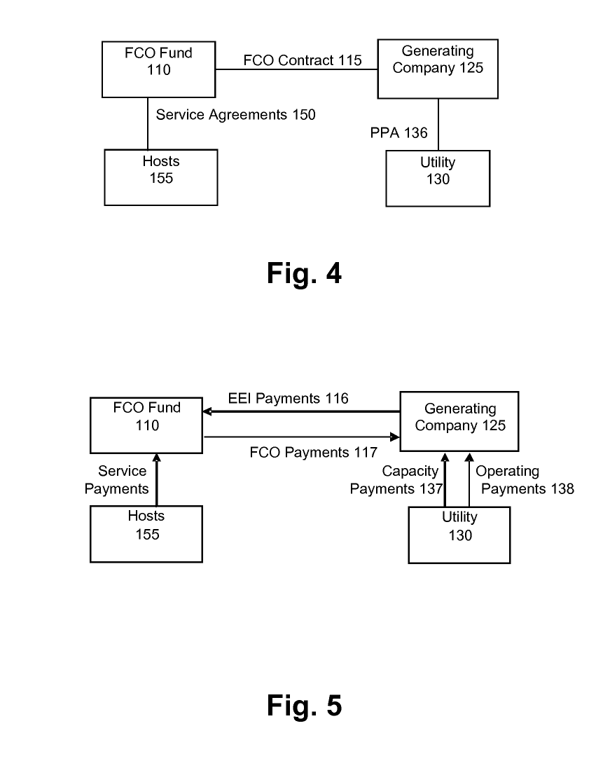

FIG. 4 and FIG. 5 show an alternative embodiment of DCD. A power purchase agreement (PPA) 136 would provide for Capacity Payments 137 and Operating Payments 138 to be paid by the utility 130 to a Generating Company 125. The Capacity Payments 137 would be equal to those of a base load power plant (CP2) and Operating Payments 138 equal to those of a base load power plant (OP2). The Generating Company 125 would enter into an FCO Contract 115 with the FCO Fund 110 that would provide for the Generating Company to make Energy Efficiency Investment (EEI) Payments 116 to the FCO Fund equal to CP2 less CP1 and the FCO Fund would make FCO Payments 117 to the Generating Company equal to OP2 less OP1.

In yet another alternative DCD arrangement, the FCO Fund 110 may contract directly with the utility 130. In such an embodiment, the utility provides the capacity payments CP2 and operating payments OP2 to the FCO Fund 110, which contracts with a third party to construct and operate the LEF power plant. The system operates similar to the systems described above except that the FCO Fund contracts with a third party for electric generation rather than with the generating company or the utility.

### EXAMPLE

In the following example, the system is described in connection with a particular type of low emission fuel power plant, namely a gas-fired power plant, such as a natural gas-fired combined cycle gas turbine (CCGT). However, it should be understood the gas-fired plant is simply an example of a reduced emission electrical generation facility. As such, the present system is not limited to a system that utilizes a gas-fired power plant. Additionally, a coal-fired plant is used as a base load electricity generation plant having normal emissions. However, it should be understood that the coal-fired plant is just an example of an electricity generation facility that produces increased emission relative to an LEF power plant

The example below compares the capital cost and operating expenses of a typical 750 Mw coal-fired generating plant constructed with best available technology to a 750 Mw natural gas CCGT plant built in conjunction with EEMs and an FCO Fund. The assumptions used in this example are highlighted below.

| Assumptions | | | |
|---|---|---|---|
| Generating Capacity | Mw | 750 | 750 |
| Capital Assumptions | | | |
| Base Load Coal | $/kW | 3,250 | 0 |
| Combined Cycle Gas Turbine | $/kW | 0 | 1,100 |
| (CCGT) | | | |
| Operating Assumptions | | | |
| Fixed O&M | $/Mw-Yr | 60,000 | 24,000 |
| Variable O&M | $/Mwh | 2.75 | 2.00 |
| Fuel | $/mmbtu | 2.25 | 9.00 |
| Heat Rate hhv | | 9,800 | 7,000 |
| CO2 | #/mmbtu | 208 | 118 |

As shown below, the capital costs of the CCGT plant plus EEM investments equals the capital cost of the displaced base load power plant, which in this instance is a coal-fired plant. The operating cost differential indicate that the FCO Fund revenues from the Service Agreements and the sale of Carbon Offsets equal $230 mm to generate a 10% operating cost advantage using DCD.

| | | | New |
|---|---|---|---|
| | | New | Base load |
| | | Base load | Gas Turbine + |
| | | Coal Plant | GCO Fund |
| Capital Costs | | $MM | $MM |
| Base Load Coal | | 2,438 | 0 |
| Combined Cycle Gas Turbine (CCGT) | | 0 | 825 |
| EEM Investments (via FCO Fund) | | 0 | 1,613 |
| Total Capital | | 2,438 | 2,438 |
| Capital Cost Savings vs. Coal | | | 0% |
| | | $MM/Year | $MM/Year |
| Operating Costs | | | |
| Fixed & Variable O&M | | 61 | 30 |
| Fuel | | 130 | 373 |
| FCO Fund Payments & Carbon Offsets | | 0 | (230) |
| Total Operating Costs | | 192 | 172 |
| Operating Cost Savings vs. Coal | | | 10% |
| CO2 Emissions | | | |
| Capacity Factor | | 90% | 90% |
| Annual Energy Output | Mwh/Yr | 5,913,000 | 5,913,000 |
| Annual Fuel Consumption | mmbtu | 57,947,400 | 41,391,000 |
| CO2 - Generation | Tonnes | 5,466,240 | 2,215,029 |
| CO2 Reduction - EEM's | Tonnes | 0 | (2,449,536) |
| Net CO2 Emissions | Tonnes | 5,466,240 | (234,508) |
| Net CO2 Emissions | #/Mwh | 2,038 | (87) |

| | |
|---|---|
| CO2 Emissions Savings vs. Coal | 104% |

In the example below, the $230 mm of payments from the FCO Fund to offset the higher operating expenses of the CCGT plant comes from Service Payments pursuant to Service Agreements with Hosts. This example provides for a portfolio of EEM projects which provide $256 mm/year in Service Payments to the FCO Fund. This amount is 111% of the $230 mm requirement under the FCO Agreement. No revenue is attributable to the sale of Carbon Offsets, although, as shown above, this method offsets 104% of the emissions from the displaced coal-fired plant.

| | | | Amount | Capital | CO2 | | Wtd. | Wtd. | Wtd |
|---|---|---|---|---|---|---|---|---|---|
| FCO Fund | Savings | % Savings | to DCD | Cost | Reduction | Portfolio | Capital | Savings | CO2 |
| EEM Project Types | $/Yr/Unit | to DCD | $/Yr/Unit | $/Unit | mt/Yr/Unit | Weight | $MM | $MM | mt/Yr |
| Heat Recovery Systems | 225,000 | 70% | 157,500 | 900,000 | 1,000 | 20% | 260 | 46 | 288,975 |
| Alternative Energy Vehicles | 6,200 | 70% | 4,340 | 45,000 | 21 | 5% | 238 | 23 | 111,226 |
| High Efficiency Refrigerators | 165 | 70% | 116 | 900 | 1.48 | 20% | 478 | 61 | 785,461 |
| Air Conditioning Upgrades | 22,000 | 70% | 15,400 | 85,000 | 146 | 20% | 254 | 46 | 435,851 |
| Boiler Replacements | 240,000 | 70% | 168,000 | 800,000 | 1,190 | 15% | 164 | 34 | 244,234 |
| Lighting Upgrade | 45,000 | 70% | 31,500 | 150,000 | 400 | 20% | 219 | 46 | 583,789 |
| | | | | | | 100% | 1,613 | 256 | 2,449,536 |

### Using DCD to Expand Low Emission Capacity Without Creating New Facilities

In the foregoing example, the base load electricity generating facility was a coal burning facility. Additional examples of base load electricity generating plants include those that convert oil or natural gas to electric power with lower efficiency than the low emission fuel power plant. Electric utilities dispatch different types of generating units based on operating cost to meet power demand that varies over the course of a day. The lowest cost base load generating units generally operate at or near full capacity all of the time. As demand increases, the next highest cost “intermediate” units are added to meet the demand. When power demand is highest, for example on a hot summer day when air conditioners are used heavily, the highest cost “peaking” generating units are added to meet this demand. Typically, coal and oil are used as a fuel for base load and intermediate generating units. Natural gas and oil are typically used as fuel for intermediate or peaking units.

Significant numbers of low emission natural gas generating units are used for intermediate or peaking duty. As a result, these units are not used for much of the year making it unnecessary, in many cases, to construct new natural gas generating units to implement DCD.

Specifically, DCD can be used to partially offload or completely displace an existing coal or oil plant with or without building or contracting for new gas plant capacity. For instance, since LEF plants typically are intermediate or peaking units, the plants typically are not used to full capacity. This excess capacity can be used to offset the capacity of a less efficient or higher emission plant, such as a coal-fired plant, operating as a base load facility. For example, a utility may operate or contract with three LEF plants that operate as intermediate dispatch plants so that they are only utilized approximately at ⅔ capacity. By utilizing these plants as base load units, the three plants provide the equivalent of an entire plant operating at or near full capacity. Therefore, rather than building a plant to replace an inefficient or high emission plant, the capital that would be directed to an existing plant can be utilized in a DCD arrangement as discussed above to offset the increased cost of future operations of the existing three LEF plants.

The methodology could further be used to phase out coal or oil capacity over time. For example, an existing base load coal plant could be displaced with DCD initially for a part of the year (such as only during periods of low seasonal power demand when excess LEF capacity may be available) and in a second but later transaction could be displaced during other times of the year with new or other low emission fuel capacity. Specifically, the owners of a facility, such as a coal-fired plant may be faced with the question of whether to incur the capital costs of modernizing such facility to reduce the emissions produced by the facility during electricity generation. The benefits of such costs are realized under a shorter period if the plant is closed in the near future and replaced with a newer facility. Therefore, to reduce the emissions, the plant can be operated at a lower output in the dispatch priority. For instance, rather than operating as a base load facility, the facility may be operated as an intermediate unit. To offset the lower output of the higher emission facility, an LEF facility may be moved up in the dispatch prioritization, so that the LEF facility provides the output lost by operating the higher emission facility less. A DCD arrangement can be utilized to compensate for the increased future operating costs of the increased use of the LEF facility. Specifically, the utility may provide EEI Payments to the FCO Fund, which may be proportional to costs associated with upgrading the high-emission facility. The FCO Fund will then provide FCO Payments to the utility proportional to the EEI payments to offset the increased fuel expenses for operating the LEF facility for more hours (i.e. as a base load or intermediate facility rather than as an intermediate or peaking facility). As with previously discussed implementations, the DCD system may be arranged so that the FCO Fund and the generating plant, and/or the utility link the operation of the LEF power plant with the reduced operation of the base load facility to create an FCO Pair.

DCD contracts can be structured so that the emissions of a specific high-emission electric generating unit is reduced as a result of implementing a specific group of EEMs. Specifically, the DCD contract between the FCO and the generating entity can specify that an LEF Plant will be a base load or intermediate dispatch plant rather than an intermediate or peaking plant. In this way, the agreement can result in an LEF plant being utilized more frequently than it might otherwise be used under a typical dispatch protocol based on its cost to generate electricity. For instance, a DCD agreement may specify that an LEF plant will be considered a base load plant. As such, a plant, such as a high emissions coal-fired plant that would otherwise be a base load plant, will be moved down in the dispatch to be an intermediate dispatch plant. As such, the lower emission LEF plant will be utilized at a higher rate than the high emission coal-fired plant that was moved down in the dispatch order.

In contrast, EEMs implemented without DCD simply reduce energy use by Hosts and do not directly enable a utility to contract for (or generate) power with a LEF plant. As a result, the typical implementation of an EEM may simply result in an LEF plant being used less, while a coal plant may continue to be used the same amount as it was before the EEMs were implemented. This feature of controlling the use of a specific high-emission electric generating unit allows for the differentiation of CO2 allowances from Hosts in the marketplace which can result in the creation of a higher value of CO2 offset from the perspective of the Host.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A method for generating cost-efficient low emission energy,
wherein a first system for generating electricity has a first cost for creating the system, a cost for generating a unit of electricity and an amount of undesirable emissions created for each unit of electricity generated by the first system, and
a second system for generating electricity has a second cost for creating the system, a cost for generating a unit of electricity and an amount of undesirable emissions created for each unit of electricity generated by the second system,
wherein the cost of creating the first system is less than the cost of creating the second system, the amount of undesirable emissions created for each unit of electricity generated by the first system is less than the amount of undesirable emissions created for each unit of electricity generated by the second system, and the cost of generating a unit of electricity using the second system is less than the cost of generating a unit of electricity using the first system, wherein the method comprises the steps of:
creating the first system for generating electricity;
providing an asset pool wherein the value of the asset pool relates to the difference between the cost of creating the second system and the cost of creating the first system;
converting the asset pool into a stream of revenue, wherein the step of converting the asset pool comprises the steps of:
identifying facilities requiring energy saving equipment;
determining the estimated energy savings that will be recognized by utilizing the energy savings equipment in the facilities; and
providing funds from the asset pool for the purchase of the energy saving equipment in exchange for an ongoing stream of future payments,
wherein the payments correlate to one of either the estimated energy savings or the cost of the energy savings equipment;
operating the first system for generating energy to produce electricity for customers; and
using the stream of future payments to reduce the cost of generating a unit of electricity using the first system so that the cost to the customer of a unit of electricity generated using the first system is approximately the same as the cost of a unit of electricity generated using the second system.

2. A method for generating cost-efficient low emission energy, comprising the steps of:
controlling the dispatch order of a plurality of electricity generating facilities, wherein the plurality of electricity generating facilities include at least a first facility, which is natural gas-fired, operating in the dispatch order as an intermediate load or peaking facility and a second facility, which is coal-fired, operating in a dispatch order as a base load or intermediate load facility; wherein the step of controlling the dispatch order comprises the steps of:
linking the operation of the first facility and the second facility so that increased operation of the first facility offsets decreased operation of the second facility; and
calculating a fuel offset payment that is proportional to the amount of increased operation of the first facility resulting from the decreased operation of the second facility, wherein the fuel offset payment is used to offset increased fuel costs resulting from increased operation of the first facility.

3. The method of claim 2 wherein an energy efficiency investment payment is made to a fund and wherein the fuel offset payment is proportional to the increased fuel cost resulting from increased operation of the first facility.

4. The method of claim 3 comprising the step of investing an amount in energy efficiency measures, wherein the amount comprises at least a portion of the energy efficiency investment payment, wherein the amount is invested in energy efficiency measures for users of energy to reduce the users' energy usage.

5. The method of claim 4 comprising the step of calculating an ongoing service payment to be provided in return for the energy efficiency measures, wherein the service payments are proportional to one of either the amount invested in energy efficiency measures or the amount of energy saved as a result of operating the energy efficiency measures.

6. The method of claim 2 wherein the increased operation of the first facility that offsets the decreased use of the second facility results in reduced production of carbon dioxide by the combined operation of the first and second facilities.

7. The method of claim 2 wherein the step of controlling the dispatch order comprises altering the dispatch order of the first facility from an intermediate load facility to a base load facility and closing or reducing the operation of the second facility.

8. The method of claim 2 wherein the step of controlling the dispatch order comprises altering the dispatch order of the first facility from an intermediate load facility to a base load facility and altering the dispatch order of the second facility from a base load facility to an intermediate load facility 9. A method for generating cost-efficient low emission energy,
wherein a first system for generating electricity has a first cost for creating the system, a cost for generating a unit of electricity and an amount of undesirable emissions created for each unit of electricity generated by the first system, and
a second system for generating electricity has a second cost for creating the system, a cost for generating a unit of electricity and an amount of undesirable emissions created for each unit of electricity generated by the second system,
wherein the amount of undesirable emissions created for each unit of electricity generated by the first system is less than the amount of undesirable emissions created for each unit of electricity generated by the second system, and the fuel cost of generating a unit of electricity using the second system is less than the fuel cost of generating a unit of electricity using the first system, wherein the method comprises the steps of:
calculating a fuel offset payment that is used to offset increased fuel costs resulting from increased operation of the first facility;
calculating an energy efficiency investment that is proportional to the fuel offset payment or the cost of capital expenditures to construct the second facility or upgrade the second facility so that the second facility produces at most, approximately the same amount of undesirable emissions for each unit of electricity generated by the first system;
creating an asset pool wherein the value of the asset pool relates to the energy efficiency investment;
converting the asset pool into a stream of revenue, wherein the step of converting the asset pool comprises the steps of:
identifying facilities requiring energy saving equipment;
determining the estimated energy savings that will be recognized by utilizing the energy savings equipment in the facilities; and
providing funds from the asset pool for the purchase of the energy saving equipment in exchange for an ongoing stream of future payments, wherein the payments correlate to the estimated energy savings or the cost of the energy savings equipment; and
using the stream of future payments to provide the fuel offset payments so that the cost to the customer of a unit of electricity generated using the first system is approximately the same as the cost of a unit of electricity generated using the second system.
